(19) United States
(12) Patent Application Publication
(10) Pub. No.: US 2007/0182310 A1
(43) Pub. Date: Aug. 9, 2007

(54) Methods and apparatus for increasing the luminescence of fluorescent lamps

(75) Inventor: Scot Olson, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/350,598

(22) Filed: Feb. 9, 2006

(51) Int. Cl. H01J 1/62; H01J 63/04

(52) U.S. Cl. 313/493

(57) ABSTRACT

Methods and apparatus are provided for increasing the luminous output of a fluorescent lamp suitable for use as a backlight in an avionics or other liquid crystal display (LCD). The apparatus includes a channel configured confine a vaporous material that produces an ultra-violet light when electrically excited. A layer of light-emitting material disposed within at least a portion of the channel is responsive to the ultra-violet light to produce the visible light emitted from the lamp. To increase the luminous output of the lamp, the surface area of the light-emitting material is increased through the presence of one or more grooves. The grooves may be longitudinal or transverse with respect to the channel.

### TECHNICAL FIELD

The present invention generally relates to fluorescent lamps, and more particularly relates to techniques and structures for improving the luminescence of fluorescent lamps such as those used in liquid crystal displays.

### BACKGROUND

A fluorescent lamp is any light source in which a fluorescent material transforms ultraviolet or other energy into visible light. Typically, fluorescent lamps include a glass or plastic tube that is filled with argon or other inert gas, along with mercury vapor or the like. When an electrical current is provided to the contents of the tube, the resulting arc causes the mercury gas within the tube to emit ultraviolet radiation, which in turn excites phosphors located inside the lamp wall to produce visible light. Fluorescent lamps have provided lighting in numerous home, business and industrial settings for many years.

More recently, fluorescent lamps have been used as backlights in liquid crystal displays such as those used in computer displays, cockpit avionics, and the like. Such displays typically include any number of pixels arrayed in front of a relatively flat fluorescent light source. By controlling the light passing from the backlight through each pixel, color or monochrome images can be produced in a manner that is relatively efficient in terms of physical space and electrical power consumption. Despite the widespread adoption of displays and other products that incorporate fluorescent light sources, however, designers continually aspire to improve the amount of light produced by the light source, to extend the life of the light source, and/or to otherwise enhance the performance of the light source, as well as the overall performance of the display.

Accordingly, it is desirable to provide a fluorescent lamp and associated methods of building and/or operating the lamp that improve the performance and lifespan of the lamp. Other desirable features and characteristics will become apparent from the subsequent detailed description of the invention and the appended claims, taken in conjunction with the accompanying drawings and this background of the invention.

### BRIEF SUMMARY

In various embodiments, methods and apparatus are provided for increasing the luminous output of a fluorescent lamp suitable for use as a backlight in an avionics or other liquid crystal display (LCD). The apparatus includes a channel configured to confine a vaporous material that produces an ultra-violet light when electrically excited. A layer of light-emitting material disposed within at least a portion of the channel is responsive to the ultra-violet light to produce the visible light emitted from the lamp. To increase the luminous output of the lamp, the surface area of the light-emitting material is increased through the presence of one or more grooves. The grooves may be longitudinal or transverse with respect to the channel.

In another embodiment, a method of making a fluorescent lamp suitable for use in a liquid crystal display includes the broad steps of deforming the surface of the channel to thereby increase the surface area of the channel, and then forming a layer of phosphor material within at least a portion of the channel to thereby create a light-emitting layer having a plurality of grooves corresponding to the deformed surface of the channel.

Other embodiments include other lamps or displays incorporating structures and/or techniques described herein. Additional detail about various exemplary embodiments is set forth below.

### BRIEF DESCRIPTION OF THE DRAWINGS

The present invention will hereinafter be described in conjunction with the following drawing figures, wherein like numerals denote like elements, and

FIG. 1 is an exploded perspective view of an exemplary flat panel display;

FIG. 2 is a cross-sectional side view of an exemplary fluorescent lamp with a protective coating provided over a light-emitting layer;

FIG. 3 is a cross-sectional side view of an exemplary fluorescent lamp showing a light-emitting layer with longitudinal grooves to increase surface area; and

FIG. 4 is a cross-sectional view of an exemplary fluorescent lamp showing a light-emitting layer with transverse grooves.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Various techniques for improving the efficiency, luminescence and/or other performance aspect of a fluorescent light source are described herein. These techniques include, for example, increasing the surface area of the light-producing material through the addition of grooves, indentations and/or the like. Each of the various techniques and structures described herein may be readily applied to all types of fluorescent light sources, including so-called “aperture lamps”, “flat lamps”, fluorescent bulbs, and the like.

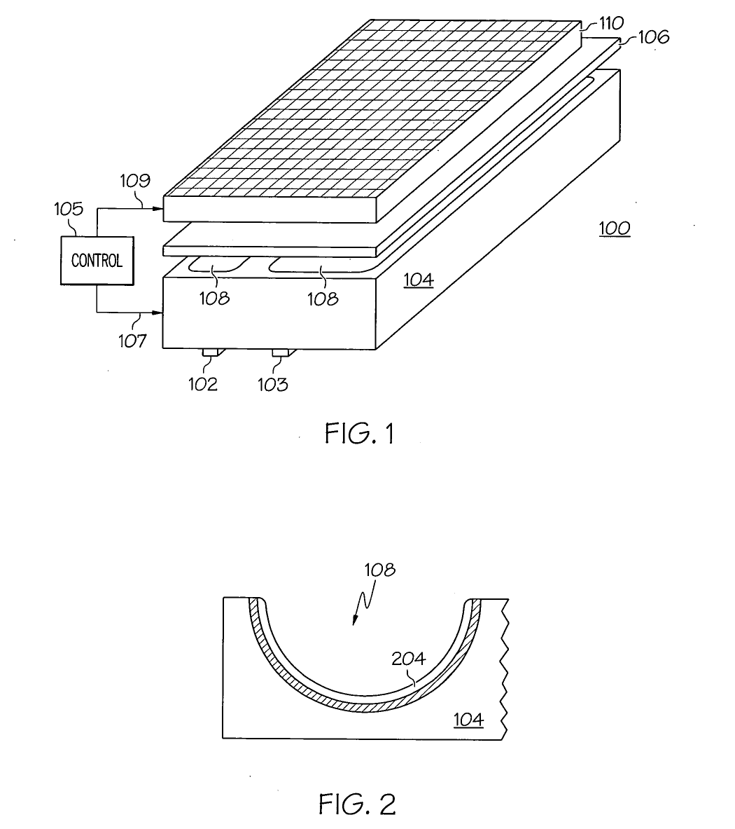

Turning now to the drawing figures and with initial reference to FIG. 1, an exemplary flat panel display 100 suitably includes a backlight assembly with a substrate 104 and a faceplate 106 confining appropriate materials for producing visible light within one or more channels 108. Typically, materials present within channel(s) 108 include argon (or another relatively inert gas), mercury and/or the like. To operate the lamp, an electrical potential is created across the channel 108 (e.g. by coupling electrodes 102, 103 to suitable voltage sources and/or driver circuitry), the gaseous mercury is excited to a higher energy state, resulting in the release of a photon that typically has a wavelength in the ultraviolet light range. This ultraviolet light, in turn, provides “pump” energy to phosphor compounds and/or other light-emitting materials located in the channel to produce light in the visible spectrum that propagates outwardly through faceplate 106 toward pixel array 110.

The light that is produced by backlight assembly 104/106 is appropriately blocked or passed through each of the various pixels of array 110 to produce desired imagery on the display 100. Conventionally, display 100 includes two polarizing plates or films, each located on opposite sides of pixel array 110, with axes of polarization that are twisted at an angle of approximately ninety degrees from each other. As light passes from the backlight through the first polarization layer, it takes on a polarization that would ordinarily be blocked by the opposing film. Each liquid crystal, however, is capable of adjusting the polarization of the light passing through the pixel in response to an applied electrical potential. By controlling the electrical voltages applied to each pixel, then, the polarization of the light passing through the pixel can be “twisted” to align with the second polarization layer, thereby allowing for control over the amounts and locations of light passing from backlight assembly 104/106 through pixel array 110. Most displays 100 incorporate control electronics 105 to activate, deactivate and/or adjust the electrical parameters 109 applied to each pixel. Control electronics 105 may also provide control signals 107 to activate, deactivate or otherwise control the backlight of the display. The backlight may be controlled, for example, by a switched connection between electrodes 102, 103 and appropriate power sources. While the particular operating scheme and layout shown in FIG. 1 may be modified significantly in some embodiments, the basic principals of fluorescent backlighting are applied in many types of flat panel displays 100, including those suitable for use in avionics, desktop or portable computing, audio/video entertainment and/or many other applications.

Fluorescent lamp assembly 104/106 may be formed from any suitable materials and may be assembled in any manner. Substrate 104, for example, is any material capable of at least partially confining the light-producing materials present within channel 108. In various embodiments, substrate 104 is formed from ceramic, plastic, glass and/or the like. The general shape of substrate 104 may be fashioned using conventional techniques, including sawing, routing, molding and/or the like. Further, and as described more fully below, channel 108 may be formed and/or refined within substrate 104 by sandblasting in some embodiments.

Channel 108 is any cavity, indentation or other space formed within or around substrate 104 that allows for partial or entire confinement of light-producing materials. In various embodiments, lamp assembly 104/108 may be fashioned with any number of channels, each of which may be laid out in any manner. Serpentine patterns, for example, have been widely adopted to maximize the surface area of substrate 104 used to produce useful light. U.S. Pat. No. 6,876,139, for example, provides several examples of relatively complicated serpentine patterns for channel 108, although other patterns that are more or less elaborate could be adopted in many alternate embodiments.

With reference now to FIG. 2, channel 108 in substrate 104 is suitably provided with a light-emitting material 202 and a protective layer 204. Channel 108 is appropriately formed in substrate 104 by milling, molding or the like, and light-emitting material 202 is applied though spraying or any other conventional technique. Light-emitting material 202 is typically a phosphorescent compound capable of producing visible light in response to “pump” energy (e.g. ultraviolet light) emitted by vaporous materials confined within channel 108. Various phosphors used in fluorescent lamps include any presently known or subsequently developed light-emitting materials, which may be individually or collectively employed in a wide array of alternate embodiments. Light emitting layer 202 may be applied or otherwise formed in channel 108 using any technique, such as conventional spraying or the like.

An optional protective layer 204 may be provided on light-emitting layer 202 to prevent argon, mercury or other vapor molecules from diffusing into the phosphor or other light-emitting material. When used, protective layer 204 may be made up of any conventional coating material such as aluminum oxide or the like. Alternatively, various embodiments could include a protective layer 204 that includes fused silica (“quartz glass”) or a similar material to prevent mercury penetration into light emitting layer 102.

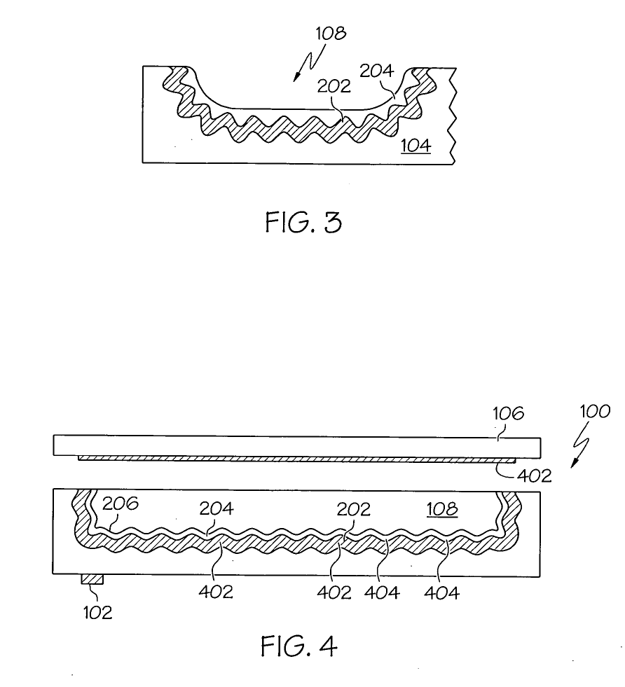

With reference now to FIG. 3, one technique for improving the efficiency of the fluorescent lamp suitably involves creating one or more grooves in the surface of light-emitting material 202. “Groove” in this context refers to any regular or irregular variation that increases the surface area of light-emitting layer 202. The exemplary embodiment shown in FIG. 3, for example, shows various grooves 302, 304, 306 created in the longitudinal direction with respect to channel 108, although alternate embodiments may provide any sort of transverse, longitudinal, oblique, irregular or other grooves along some or all of channel 108. FIG. 4, for example, shows various grooves 402, 404 formed in a transverse direction with respect to channel 108. By increasing the surface area of the light emitting layer 102 facing toward channel 108, the amount of light produced by the layer can be substantially increased. That is, the presence of one or more grooves 302, 304, 306, 402, 404 in light-emitting layer 202 increases the amount of light emitting material 202 exposed to pump radiation from vaporous materials in channel 108, thereby increasing the amount of visible light produced within channel 108.

In various embodiments, then, a fluorescent lamp assembly 104/106 may be made by simply forming a substrate 104 with one or more channels 108 of appropriate size and shape, applying the light emitting layer 202 within channel(s) 108, and then applying a suitable layer 204 of protective material on at least a portion of the light emitting material 202. Substrate 104 may be formed and shaped by molding, milling, sandblasting and/or other techniques. Light emitting layer 202 may be applied on the grooved substrate 104 by spraying or otherwise applying a layer of phosphor or other material. Finally, optional protective layer 204 may be applied by sputtering, deposition and/or any other suitable technique.

Grooves 302, 304, 306 may be created in any manner. In an exemplary embodiment, such grooves are created by deforming the surface of substrate 104 by molding, for example, or by milling, sandblasting or otherwise processing substrate 104 after molding in any appropriate manner. The various grooves can be readily sandblasted into the upper surface of substrate 104 facing into channel 108, for example, such that corresponding grooves form in light-emitting layer 202 when the layer is sprayed or otherwise applied in channel 108. Alternatively, light-emitting layer 202 may be processed after application to create regular or irregular surface deformities as appropriate. As noted above, FIG. 4 shows a fluorescent lamp 100 that includes several transverse-oriented grooves 402, 404 in light-emitting layer 202.

FIG. 4 also shows the placement of a faceplate or cover 106 with respect to channel 108. Cover 106 is typically made of glass, ceramic glass or plastic, and is suitably attached to substrate 104 by glass fritting or the like in a manner that seals the vaporous materials within channel 108. In various embodiments, a reflective coating 406 is suitably applied to the internal or external face of cover 106 to further increase the efficiency of lamp 100. Reflective coating 406 is designed to reflect light of certain wavelengths while transmitting light of other wavelengths; for example, coating 406 may be designed to reflect ultraviolet light back toward channel 108 while allowing visible light to transmit through cover 106, toward pixel array 110 (FIG. 1). Various layers of metals, for example, could provide such functionality, although the particular coatings used to implement reflective layer 406 vary from embodiment to embodiment.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims and their legal equivalents.

What is claimed is:

1. A fluorescent light source for providing a visible light, the light source comprising:
a channel configured to confine a vaporous material that produces an ultra-violet light when electrically excited; and
a layer of light-emitting material disposed within at least a portion of the channel that is responsive to the ultra-violet light to produce the visible light, wherein the layer of light emitting material comprises an upper surface opposite the channel having at least one groove.

2. The fluorescent light source of claim 1 wherein the groove is a longitudinal groove with respect to the channel.

3. The fluorescent light source of claim 1 wherein the groove is a transverse groove with respect to the channel.

4. The fluorescent light source of claim 1 wherein the channel comprises a grooved surface, and wherein the at least one groove in the fluorescent light substantially corresponds to the grooved surface of the channel.

5. The fluorescent light source of claim 4 wherein the grooved surface of the channel exhibits regular pattern of grooves.

6. The fluorescent light source of claim 5 wherein the regular pattern of grooves comprises a plurality of grooves arranged longitudinally with the channel.

7. The fluorescent light source of claim 5 wherein the regular pattern of grooves comprises a plurality of grooves arranged transverse to the channel.

8. The fluorescent light source of claim 1 further comprising a protective coating substantially covering the layer of light-emitting material.

9. The fluorescent light source of claim 9 wherein the protective material comprises fused silica.

10. The fluorescent light of claim 1 further comprising a substantially transparent cover displaced on the channel to confine the vaporous material.

11. The fluorescent light source of claim 10 wherein the cover comprises an ultraviolet-reflective coating formed thereon configured to reflect the ultra-violet light toward the layer of light-emitting material.

12. A flat panel display comprising the light source of claim 1.

13. A fluorescent light source for providing a visible light, the light source comprising:
a channel configured confine a vaporous material comprising mercury that produces an ultra-violet light when electrically excited, the channel comprising a grooved surface; and
a layer of light-emitting phosphor material disposed within at least a portion of the channel that is responsive to the ultra-violet light to produce the visible light, wherein the layer of light-emitting phosphor comprises a plurality of grooves corresponding to the grooved surface of the channel.

14. The fluorescent light source of claim 13 wherein the plurality of grooves comprises longitudinal grooves with respect to the channel.

15. The fluorescent light source of claim 13 wherein the plurality of grooves comprises transverse grooves with respect to the channel.

16. A method of making a fluorescent light source on a substrate having a channel formed therein, the method comprising the steps of:
deforming the surface of the channel to thereby increase the surface area of the channel; and
forming a layer of phosphor material within at least a portion of the channel to thereby create a light-emitting layer having a plurality of grooves corresponding to the deformed surface of the channel.

17. The method of claim 16 wherein the deforming step is practiced by sandblasting the surface of the channel.

18. A fluorescent light source formed by the method of claim 16.

19. A fluorescent light source formed by the method of claim 17.

20. A flat panel display having a light source formed by the method of claim 16.
